(19) United States
(12) Patent Application Publication
(10) Pub. No.: US 2012/0011496 A1
(43) Pub. Date: Jan. 12, 2012

(54) SERVICE PROVIDING APPARATUS, SERVICE PROVIDING SYSTEM, METHOD OF PROCESSING DATA IN SERVICE PROVIDING APPARATUS, AND COMPUTER PROGRAM

(75) Inventor: Hisashi Shimamura, Tokyo (JP)

(73) Assignee: NEC CORPORATION, Tokyo (JP)

(21) Appl. No.: 13/255,819

(22) PCT Filed: Mar. 29, 2010
(86) PCT No.: PCT/JP2010/002282

§ 371 Date: Sep. 9, 2011

(30) Foreign Application Priority Data
Mar. 30, 2009 (JP) 2009-083117
Feb. 26, 2010 (JP) 2010-041474

(51) Int. Cl. G06F 9/445

(52) U.S. Cl. 717/170

(57) ABSTRACT

A service providing apparatus (200) includes: a version information storing unit (207) storing a service to be provided to each of users (13) and version information of this service; a loader managing unit (210) storing a default class group (221) and update class groups (231) for respective versions; a default loader (223) reading out and executing the default class group (221) from the loader managing unit (210); a differential loader (233) reading out and executing the update class group (231); a receiving unit (203) receiving service usage requests; a specifying unit (205) referring to the version information storing unit (207) to specify a version corresponding to the user (13) of the requestor; an object managing unit (241) using the default loader (223) and the specified version of the differential loader (233) to generate a service object of aversion suitable for the user (13) and execute processing; and a providing unit (243) providing a service to the user (13).

### TECHNICAL FIELD

The present invention relates to a service providing apparatus, a service providing system, a method of processing a data in the service providing apparatus, and a computer program, and more particularly, the present invention relates to a service providing apparatus, a service providing system, a method of processing a data in the service providing apparatus and a computer program which multiply provide a plurality of versions of services.

### BACKGROUND ART

In recent years, a service providing model is gaining attention which uses Software as a Service (SaaS)/Application Service Provider (ASP) which provides various services on a single platform, to a plurality of users. As a typical service of this mode, there is Salesforce.com (http://www.salesforce.com/jp/). The SaaS/ASP type service releases a certain Application Program Interface (API) to allow users to use functions using protocols such as Simple Object Access Protocol (SOAP) and HyperText Transfer Protocol (HTTP).

With the system disclosed in Patent Document 1 (Japanese Patent Application Laid-Open No. 2008-123183), the SaaS type service provides a service in units of functions of software to use a minimum service which the users require for each use.

Generally, this service is updated to a new version on an irregular basis to fix bugs and improve functions, and individual APIs and functions realized by the APIs are changed, added and deleted.

As a techniques related to this update of a service, Patent Document 2 (Japanese Patent Application Laid-Open No. 2006-011801) discloses a method of automatically updating an update module to the latest version. However, services are generally updated continuously and there are not simply two types of a new version and older version as in the technique disclosed in Patent Document 1 but there are generally the latest version and a plurality of older versions such as a plurality of versions of V1.0, V1.01, V1.12 and V2.0, and therefore it is necessary to continue providing older version services for part of users.

In addition to requirement of continuously providing a plurality of versions of services, most of SaaS/ASP type services need continuously provide services when a service is updated. Hence, existing ASP providers have adopted a method of continuing older version services, deploying a new version service to another server hardware or a virtual Operating System (OS) using a virtualization technology represented by VMWare (registered trademark) or Xen (registered trademark) on which these services are operating, and switching the new Also, the API providers continue providing an older version service by leaving part of hardware which provides the older version service for part of users who cannot follow an API or function of a new version.

FIG. 19 illustrates an example of switching in this case. A user group 3 (U1) uses a service provided by a service providing apparatus group 10 of a V1.00 version through a load distributor 7. In this case, the load distributor 7 has a function of adequately distributing a plurality of requests from multiple users 3 to service providing apparatuses 11 and 12 in the service providing apparatus group 10. When receiving a request from a user in a request receiving/responding unit 101, the service providing apparatus 11 obtains an object required for processing from a loader 102. The loader 102 reads a class group 103 in which V1.00 service processing is implemented upon deployment of the service to be loaded therein. The loader 102 then generates an object required for processing based on the class group 103, and returns the object to the request receiving/responding unit 101. When processing is finished, the request receiving/responding unit 101 returns a result to the user 3 as a response.

Further, to update this service to a V1.01 version, a service providing apparatus group 15 of the V1.01 version is additionally prepared. In the service providing apparatuses 16 and 17 of the service providing apparatus group 15, the request receiving/responding unit 101 and loader 102 are the same as those of the service providing apparatus group 10. They have an only difference in the class group 153 which is implemented a processing of V1.01 service and is read and loaded onto the loader 102.

Then, a setting of the load distributor 7 is changed at an adequate timing, connection to the V1.00 version of the service providing apparatus group 10 is cut and requests from the user group 3 are allocated to the service providing apparatuses 16 and 17 in the V1.01 version of the service providing apparatus group 15. The load distributor 7 allocates requests from a user group U2 included in the users 3, the user group U2 continuing to use the V1.00 version of the service to the V1.00 version of the service providing apparatus group 10. However, a use of the older version is generally inclined to decrease and therefore the administrator adequately removes the service providing apparatuses in the V1.00 version of the service providing apparatus group 10 or makes a transition of the service providing apparatuses to the V1.01 version, thereby causing the older version of the service providing apparatus group 10 to degenerate.

In the above methods of multiply managing versions multiply, a common portion of the services is deployed, while a plurality of services large parts of which are the same with each other and small parts of which are different from each other are deployed. For example, even when only part of a class of the V1.00 service class group 103 is updated, the V1.01 service class group 153 also needs to read a common portion which is not updated.

By contrast with these methods, Patent Document 3 (Japanese Patent Application Laid-Open No. 2003-337702) discloses an example of a system of changing part of a highly modularized software and deploying software again without stopping the entire software, as an existing technique of renewing only a necessary portion of the service instead of preparing a copy of the entire service upon service update.

Further, Patent Document 4 (Japanese Patent Application Laid-Open No. 2008-165377) discloses a system employing a configuration of optimizing a method of managing a plurality of versions of libraries on a file system when one application is executed. This system enables a use of a different version of a single library on a single system and allows a package to be downgraded to a previous older version by backing up a program of the older version even after the version of the package is updated.

### RELATED DOCUMENTS

### Patent Documents

Patent Document 1: Japanese Patent Application Laid-Open No. 2008-123183
Patent Document 2: Japanese Patent Application Laid-Open No. 2006-011801
Patent Document 3: Japanese Patent Application Laid-Open No. 2003-337702

Patent Document 4: Japanese Patent Application Laid-Open No. 2008-165377

### DISCLOSURE OF THE INVENTION

By the way, as described above, with the SaaS/ASP type service, it is necessary to multiply provide a plurality of versions of services according to requirements of users of service request sources.

In the systems disclosed in the above documents, the server side such as ASP does not provide a service by executing an application and returning the result to a user, and a terminal side executes an application and does not need to simultaneously execute a plurality of versions of the same application, and therefore, if the technique of the above documents is applied to a server and a plurality of versions of applications are executed simultaneously, it is necessary to individually launch applications by setting an adequate mount point per version. In this case, a library which is common among different versions of applications is redundantly read onto a memory, and therefore there are problems that the memory use capacity increases and a greater load is applied.

It is therefore an object of the present invention to provide a service providing apparatus, system, method and program which can promote efficiency of calculator resources required to continue providing the older versions of the services as much as possible, and multiply provide a plurality of versions of services according to requirements of service request sources, which are the above tasks.

According to the present invention, there is provided a service providing apparatus includes: a version information storing unit which stores therein services to be provided to each of users, and version information of the service, the service and the version information being associated with each other; a default class group storing unit which stores therein a default class group of the oldest version among the services to be provided to the users; an update version-specific class group storing unit which stores update version-specific class groups for respective versions updated subsequent to the oldest version, the update version-specific class group including a differential class group having a difference with the default class group; a default loading unit which reads out and executes the default class group stored in the default class group storing unit; an update version-specific differential loading unit which is provided to each of the update version-specific class groups, and which reads out and executes each of the update version-specific class groups stored in the update version-specific class group storing unit; a receiving unit which receives a request for use of the service from the user; a specifying unit which refers to the version information storing unit to specify a version suitable for the user from whom the request is received; a service object managing unit which generates a service object of the specified version suitable for the user and executes processing, by using the default loading unit and the update version-specific differential loading unit associated with the specified version of the update version-specific class group; and a providing unit which provides the service matching the request to the user according to a result of executing the processing.

According to the present invention, there is provided a service providing system includes: a plurality of the above described service providing apparatuses; and a load distributing apparatus which determines a service providing apparatus which provides a service in response to a request of a user, according to load states of the plurality of service providing apparatuses, and assigns the service providing apparatus, and the plurality of service providing apparatuses storing the same version of the default class group in the default class group storing unit, thereby equally providing to the user all versions of all services which are being applied to use, and storing all same versions of the update version-specific class groups which are being applied to use, in the update version-specific class group storing unit.

According to the present invention, there is provided a method of processing data in a service providing apparatus, wherein the service providing apparatus includes: a version information storing apparatus which stores therein services to be provided to each of users, and version information of the service, the service and the version information being associated with each other; a default class group storing apparatus which stores therein a default class group having the oldest version among the service to be provided to the users; an update version-specific class group storing apparatus which stores therein update version-specific class groups for respective versions updated subsequent to the oldest version, the update version-specific class group including a differential class group having a difference with the default class group; a default loader which reads out and executes the default class group stored in the default class group storing apparatus; an update version-specific differential loader which is provided to each of the update version-specific class groups, and which reads out and executes each of the update version-specific class groups stored in the update version-specific class group storing apparatus; wherein the method of processing data comprises: storing, by the service providing apparatus, services to be provided to each of users, and version information of the service in the version information storing apparatus, the service and the version information being associated with each other; storing, by the service providing apparatus, the default class group in the default class group storing apparatus; storing, by the service providing apparatus, the update version-specific class group in the update version-specific class group storing apparatus for each version updated subsequent to the oldest version; receiving, by the service providing apparatus, a request for use of the service from the user; referring, by the service providing apparatus, to the version information storing apparatus to specify a version suitable for the user from whom the request is received; generating, by the service providing apparatus, a service object of the specified version suitable for the user and executing processing, by using the default loader and the update version-specific differential loader associated with the specified version of the update version-specific class group; and providing, by the service providing apparatus, the service matching the request to the user according to a result of executing the processing.

According to the present invention, there is provided a computer program for controlling a service providing apparatus, the computer includes: a version information storing apparatus which stores therein services to be provided to each of users, and version information of the service, the service and the version information being associated with each other; a default class group storing apparatus which stores therein a default class group having the oldest version among the services to be provided to the users; an update version-specific class group storing apparatus which stores therein update version-specific class groups for respective versions updated subsequent to the oldest version, the update version-specific class group including a differential class group having a difference with the default class group; a default loader which reads out and executes the default class group stored in the default class group storing apparatus; an update version-specific differential loader which is provided to each of the update version-specific class groups, and which reads out and executes each of the update version-specific class groups stored in the update version-specific class group storing apparatus, and the computer program causes the computer to execute: a procedure for storing services to be provided to each of the users, and version information of the service in the version information storing apparatus, the service and the version information being associated with each other; a procedure for storing the default class group in the default class group storing apparatus; a procedure for storing the update version-specific class group in the update version-specific class group storing apparatus for each version updated subsequent to the oldest version; a procedure for receiving a request for use of the service from the user; a procedure for referring to the version information storing apparatus to specify a version suitable for the user from whom the request is received,; a procedure for generating a service object of the specified version suitable for the user and executing processing, by using the default loader and the update version-specific differential loader associated with the specified version of the update version-specific class group; and a procedure for providing the service matching the request to the user according to a result of executing the processing.

In addition, any arbitrary combination of the above components and any variation of the present invention in expression among a method, an apparatus, a system, a recording medium and a computer program are also effective as aspects of the present invention.

In addition, the components of the present invention are unnecessary to be independent of one another. For example, two or more components may be formed as a single member, one component maybe formed with two or more members, one component may be part of another component, or part of a component may overlap with part of another component.

Further, a plurality of procedures of the method of processing the data and the computer program according to the present invention are described in order. However, the order in the description does not limit actual order. Accordingly, when the method of processing the data and the computer program according to the present invention are implemented, the sequential order of the procedures may be changed without affecting the contents of the procedures.

Furthermore, the procedures according to the method of processing the data and the computer program according to the present invention are not necessarily carried out in different timings from one another. One procedure may be carried out while another procedure is being carried out, or the timing of the procedure may partially or entirely overlap with the timing of another procedure.

The present invention provides a service providing apparatus, a service providing system, a method of processing a data in the service providing apparatus and a computer program which prevent a service from being stopped upon a service update, and inconsistency from occurring on a user side.

### BRIEF DESCRIPTION OF THE DRAWINGS

The foregoing objects and the other objects, features, and advantages will be more apparent from an exemplary embodiment to be described below and accompanying drawings.

FIG. 1 is a block diagram illustrating a configuration of a service providing system according to an exemplary embodiment of the present invention.

FIG. 2 is a view illustrating an example of a structure of a version information management table stored in a version information storing unit of a service providing apparatus according to an exemplary embodiment of the present invention.

FIG. 3 is a flowchart illustrating an example of an operation of a service providing system according to an exemplary embodiment of the present invention.

FIG. 4 is a flowchart illustrating an example of an operation upon a service object operation in a service providing system according to an exemplary embodiment of the present invention.

FIG. 5 is a block diagram illustrating a configuration of a service providing system according to an exemplary embodiment of the present invention.

FIG. 6 is a view illustrating an example of a structure of a session information table stored in a usage situation storing unit of a service providing apparatus according to an exemplary embodiment of the present invention.

FIG. 7 is a flowchart illustrating an example of an operation of a service providing system according to an exemplary embodiment of the present invention.

FIG. 8 is a block diagram illustrating a configuration of a service providing system according to an exemplary embodiment of the present invention.

FIG. 9 is a flowchart illustrating an example of an operation upon deletion of a version of a service object in a service providing system according to an exemplary embodiment of the present invention.

FIG. 10 is a block diagram illustrating a configuration of a service providing system according to an exemplary embodiment of the present invention.

FIG. 11 is a flowchart illustrating an example of a registration operation upon addition of a version of a service object in a service providing system according to an exemplary embodiment of the present invention.

FIG. 12 is a block diagram illustrating a configuration of a service providing system according to an exemplary embodiment of the present invention.

FIG. 13 is a view illustrating an example of user request data according to an exemplary embodiment of the present invention.

FIG. 14 is a view illustrating an example of session added user request data according to an exemplary embodiment of the present invention.

FIG. 15 is a view illustrating an example of a service response to a service request according to an exemplary embodiment of the present invention.

FIG. 16 is a block diagram illustrating a configuration of a service providing system according to an exemplary embodiment of the present invention.

FIG. 17 is a flowchart illustrating an example of a registration operation upon addition of a version of a service object in a service providing system according to an exemplary embodiment of the present invention.

FIG. 18 is a view for describing an example of updating an existing class according to Aspect description according to an example of the present invention.

FIG. 19 is a block diagram illustrating an example of a configuration including a service providing apparatus to which a different version of a service is deployed.

### DESCRIPTION OF EXEMPLARY EMBODIMENTS

### First Exemplary Embodiment

Hereinafter, exemplary embodiments of the present invention will be described using drawings. In addition, the same components will be assigned the same reference numerals and will not be repeated in all drawings.

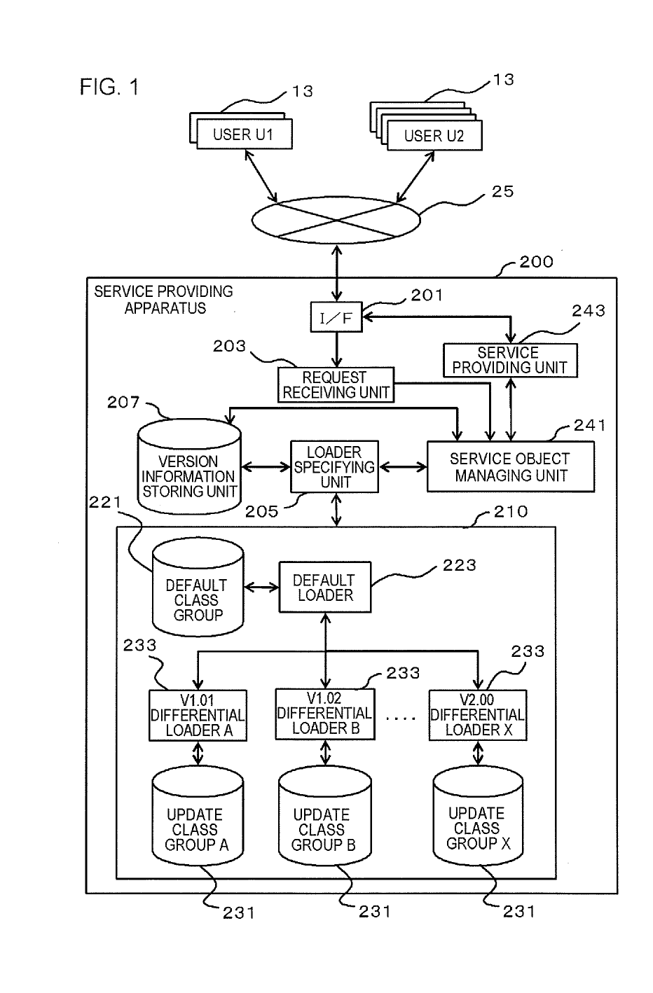

FIG. 1 is a block diagram illustrating a configuration of a service providing system according to an exemplary embodiment of the present invention.

First, “user” in this specification means a subject in general which uses services provided by the service providing apparatuses, and also means human being, terminal devices and programs used by human being, and apparatuses and programs which are operated irrespective of a human interaction.

Further, “user” may be a group of users which put together a plurality of users such as a company or department of a company, or an individual user.

Firstly, the precondition of the present invention will be described. A service object according to the present invention includes an instance which gives substance to a plurality of classes. This instance is generated from classes managed by loaders and arranged on a memory, thereby making a service object executable.

Services provided by the system according to the present invention are some functions realized by software, and include not only commercial packaged software such as a word processor and spreadsheet, but also so-called groupware which shares information in the company by means of a schedule, project management, bulletin board, electronic conference room and distribution of web mails, business software which is used for finance and accounting, is used for sharing data using an online storage, is specialized in each type of business or in each company, or is used for general-purpose business management, financial management, production management or customer relationship management (CRM) client management, and software with a library function of advanced scientific computation such as computer aided design (CAD), structural computation, media processing such as an image processing and a sound processing, and fluid simulation.

Particularly, the system according to the present invention is useful for Web application services whose functions are frequently updated and which are imposed by a large number of users.

A service providing apparatus 200 according to an exemplary embodiment of the present invention includes: a version information storing unit (version information storing unit 207) which stores therein services to be provided to each of users 13, and version information of this service, the service and the version information being associated with each other; a default class group storing unit (loader managing unit 210) which stores therein a default class group 221 having the oldest version among the services to be provided to the users 13; an update version-specific class group storing unit (loader managing unit 210) which stores therein update version-specific class groups (update class groups 231) for respective versions updated subsequent to the oldest version, the update version-specific class group (update class group 231) including a differential class group having a difference with the default class group 221; a default loading unit (default loader 223) which reads out and executes the default class group 221 stored in the loader managing unit 210; an updated version-specific differential loading unit (differential loader 233) which is provided to each of the update class groups 231, and respectively reads out and executes each of the update class groups 231 stored in the loader managing unit 210; a receiving unit (request receiving unit 203) which receives requests for use of services from the users 13; a specifying unit (a loader specifying unit 205) which refers to the version information storing unit 207 to specify a version suitable for the user 13 from whom the request is received; a service object managing unit 241 which generates a service object of the specified version suitable for the user 13 and executes processing, by using the default loader 223 and the differential loader 233 associated with the specified version of the update class group 231 suitable for the user 13; and a providing unit (service providing unit 243) which provides a service matching the request to the user 13 according to an execution result of the processing.

The users 13 (users U1 and U2 in the drawings) transmit service requests to the service providing apparatus 200. In FIG. 1, the number of users, the amount of use of services and frequency of using services of the users U2 are more than the users U1. Further, the number of users, the amount of use of services or the frequency of using services differs according to the users 13.

The service providing apparatus 200 includes an interface unit (I/F) 201, and a request receiving unit 203, a loader specifying unit 205, a version information storing unit 207, a loader managing unit 210, a service object managing unit 241 and a service providing unit 243.

The loader managing unit 210 includes a default class group 221, a default loader 223, at least one differential loader 233 and update class groups 231 associated with respective differential loaders 233.

The service providing apparatus 200 may be a computer which includes a Central Processing Unit (CPU), a memory, a hard disk and a communication apparatus, not shown in the drawings, and to which an input apparatus such as a keyboard and a mouse and an output apparatus such as a display and a printer can be connected. The service providing apparatus 200 may realize each function of each component by the computer which executes processing according to a computer program stored, for example, in a recording medium (a magnetic disk, a semiconductor memory, an optical disk, or the like). In addition, configurations of parts which are irrelevant to the essence of the present invention are not shown in each following drawing.

Further, the respective components of the service providing apparatus are realized by any combination of hardware and software of an arbitrary computer mainly including a CPU, a memory, a program which is loaded into the memory and designed to realize the components shown in FIG. 1, a storage unit such as a hard disk that stores the program, and a network connection interface. It is obvious to those skilled in the art that various modifications may be made to a method and an apparatus for realizing the components. The drawings described hereafter show functional blocks, instead of the structure of the hardware.

Further, the CPU reads a program from the hard disk into the memory and executes the program, thereby making it possible to realize each function of each unit.

The computer program according to the exemplary embodiment is a computer program of controlling the service providing apparatus 200, and is described to cause the computer to execute: a procedure for storing services to be provided to each of the users 13 and version information of the service in the version information storing unit 207; a procedure for storing the default class group 221 in the loader managing unit 210; a procedure for storing the update class groups 231 respectively in the loader managing unit 210 for each version updated subsequent to the oldest Version; a procedure for receiving a request for use of service from the user 13; a procedure for referring to the version information storing unit 207 to specify a version suitable for the user 13 from whom the request is received; a procedure for generating a service object of the version suitable for the user 13 and executing processing, by using the default loader 223 and the differential loader 233 associated with the specified version of the update class group 231; and a procedure for providing the service matching the request, to the user 13 according to an execution result of the processing.

The interface unit 201 communicates with terminals or apparatuses of the users 13 through the network 25 such as Internet, local area network (LAN) or wide area network (WAN). The request receiving unit 203 receives a request from the users 13 through the network 25, and extracts various pieces of information from the content of the received request to pass to the service object managing unit 241. More specifically, the request receiving unit 203 extracts information for specifying the requestor, an identification (ID) for identifying a series of relevant requests, information for identifying a service requested to be used and a parameter of the service requested to be used, from the request content received from the users 13 to pass to the service object managing unit 241. In addition, a series of relevant requests in particular is referred to as “session”, and the ID of this session is referred to as a session ID below with the present invention.

The service object managing unit 241 configures and executes an adequate service object for the user 13 of the requestor, based on the parameter received from the request receiving unit 203. More specifically, the service object managing unit 241 passes the parameter received from the request receiving unit 203, to the loader specifying unit 205, and requests a suitable version of the loader for the user 13. Further, the service object is generated by using the loader returned from the loader specifying unit 205. Furthermore, the parameter is passed to this service object and processing is performed to pass the result to the service providing unit 243.

According to the request from the service object managing unit 241, the loader specifying unit 205 specifies an adequate loader according to the version of a service used by each user. More specifically, the loader specifying unit 205 obtains version information which needs to be provided to the user 13 of the requestor, from the version information management table 700 of the version information storing unit 207. In addition, when the oldest version is requested, only the default loader 223 is obtained without acquiring the differential loader 233.

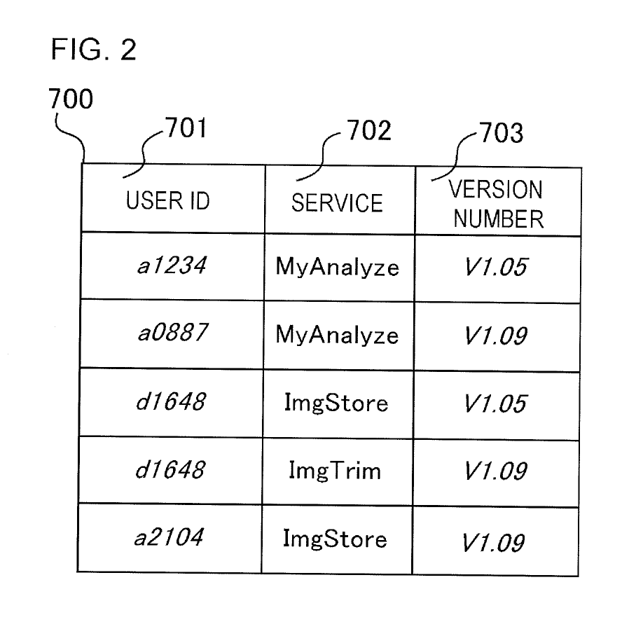

The version information storing unit 207 stores information on which version of a service is used by each user. FIG. 2 is a view illustrating an example of a structure of the version information management table 700 stored in the version information storing unit 207. As illustrated in FIG. 2, the version information management table 700 includes a user ID column 701, service name column 702 and version number column 703 with which respectively associate user IDs of the users 13, services to be provided to the users 13, and version numbers of services to be provided. In addition, the version number column 703 enables the version number of the service not only to be designated by a specific version, but also to be designated as the latest version at all times.

Back to FIG. 1, the service providing unit 243 receives a processing result from the service object managing unit 241 to provide to the user 13 through the network 25. By this means, it is possible to provide a service matching the request of the user 13.

In the loader managing unit 210, the default loader 223 manages the default class group 221 which is common among all users 13 of the system. The differential loaders 233 include a plurality of differential loaders A to X which manage a plurality of update class groups 231 respectively derived from the different versions of the default class groups 221. The default loader 223 and all differential loaders A to X have a parent and child relationship, and the default loader 223 is the parent of all differential loaders 233. In addition, the number of the differential loaders 233 corresponds to the number of versions which need to be provided, and the version numbers such as V1.01, V1.02 and V2.00 and the number of loaders in FIG. 1 are only examples. Further, the number of differential loaders 233 corresponds to the number of versions which need to be provided, and is not limited to three in FIG. 1.

The default class group 221 which stores necessary class groups for realizing the oldest version service is loaded on the memory by the default loader 223. Further, the update class groups 231 including classes of updated portions of newer versions than the oldest version are loaded by the differential loaders 233 for respective versions.

The operation of the service providing system according to the exemplary embodiment thus configured will be described below.

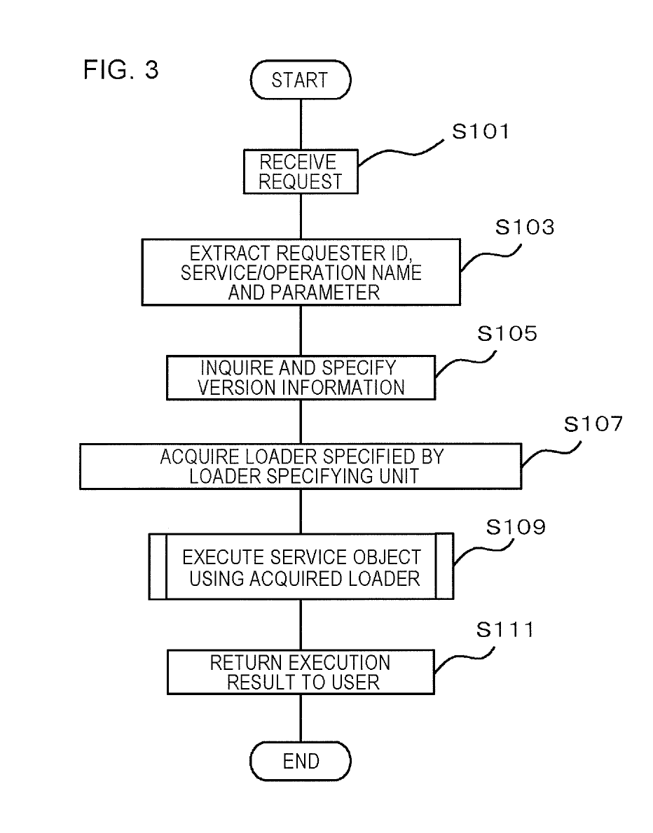

FIG. 3 is a flowchart illustrating an example of an operation of a service providing system according to the exemplary embodiment. The operation will be described below using FIG. 1 to FIG. 3.

According to the data processing method of the service providing apparatus according to the exemplary embodiment, the method of processing data includes: storing, by the service providing apparatus 200, services to be provided to each of users 13, and version information of this service in the version information storing unit 207, the service and the version information being associated with each other; storing, by the service providing apparatus 200, the default class group 221 in the loader managing unit 210, storing, by the service providing apparatus 200, the update class group 231 in the loader managing unit 210 for each version updated subsequent to the oldest version; receiving, by the service providing apparatus 200, a request for use of the service from the user 13 (step S101); referring, by the service providing apparatus 200, to the version information storing unit 207, to specify a version suitable for the user 13 from whom the request is received (step S105); generating, by the service providing apparatus 200, a service object of the specified version suitable for the user 13 and executing processing, by using the default loader 223 and the differential loader 233 associated with the specified version of the update class group 231 suitable for the user 13 (step S107 and step S109); and providing, by the service providing apparatus 200, the service matching the request to the user 13 according to an execution result of the processing (step S111).

More specifically, the request receiving unit 203 first receives request data from the user 13 (step S101). Then, the request receiving unit 203 extracts the user ID of the requestor, a service or operation name, the parameter of the service requested to be used, from the received request data to pass to the service object managing unit 241 (step S103). The loader specifying unit 205 receives the parameter from the service object managing unit 241, and the loader specifying unit 205 obtains version information which needs to be provided to the user 13 from the user ID by referring to the version information storing unit 207 (step S105).

Further, the loader specifying unit 205 accesses the loader managing unit 210, and obtains one of the differential loaders 233 matching the obtained version and default loader 223 (step S107). Then, the loader specifying unit 205 returns the obtained differential loader 233 and default loader 223 to the service object managing unit 241. When the oldest version is provided to the user 13, the loader specifying unit 205 returns only the default loader 223 to the service object managing unit 241 without selecting the differential loader 233.

The service object managing unit 241 receives the differential loader 233 and default loader 223 from the specifying unit 205, and executes the service object requested by the user 13 by using the obtained loaders (step S109). The service object managing unit 241 returns this execution result to the user 13 through the service providing unit 243 (step S111), and finishes processing. This results in that the service is provided to the user 13 from the service providing unit 243 through the network 25.

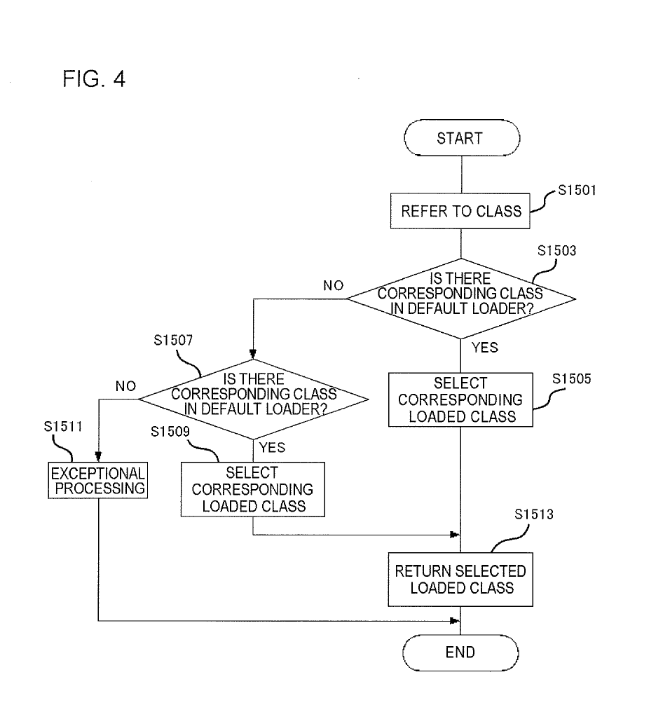

FIG. 4 is a flowchart illustrating an example of an operation upon a service object operation in the service providing system according to an exemplary embodiment of the present invention. Particularly, the service object operation in the service providing system will be described. Hereinafter, how a loader is used upon the service object operation will be described with reference to FIG. 4.

In the service object managing unit 241, a reference to a class in a code is made upon the service object operation (step S1501). When this reference is made to the loaded class in the loader, it is first confirmed whether or not there is a corresponding class in the differential loader returned from the loader specifying unit 205 (step S1503). When there is a corresponding class (YES in step S1503), this corresponding class is selected as the loaded class which is actually referred to (step S1505). When there is no corresponding class in the differential loader (NO in step S1503) or only the default loader 223 is passed from the loader specifying unit 205 (NO in step S1503), it is confirmed whether or not there is a corresponding class in the default loader 223 (step S1507).

When there is a corresponding class (YES in step S1507), this corresponding class is selected as the loaded class which is actually referred to (step S1509). When there is no corresponding class even in the default loader 223 (NO in step S1507), an error that says that it is impossible to find any class is given and exceptional processing is performed (step S1511).

After the loaded class which is referred to is selected in step S1505 or step S1509, this loaded class is returned to the service object of the reference source (step S1513). According to this operation, it is possible to refer to the loaded class in the differential loader preferentially and refer to the class in the default loader 223 when there is no corresponding class.

As described above, the service providing system according to the exemplary embodiment can multiply provide a plurality of versions of services according to requirements of requestor (user 13) of services, and efficiently provide a suitable version of the service for the user 13. The service providing apparatus 200 according to the exemplary embodiment holds only an update class for each version of the services which is requested to be provided and shares the common class, thereby making it unnecessary to read a class multiply, and can reduce cost of providing a plurality of versions of services. That is, it is possible to promote efficiency of calculator resources required to continue to provide older version services as much as possible.

### Second Exemplary Embodiment

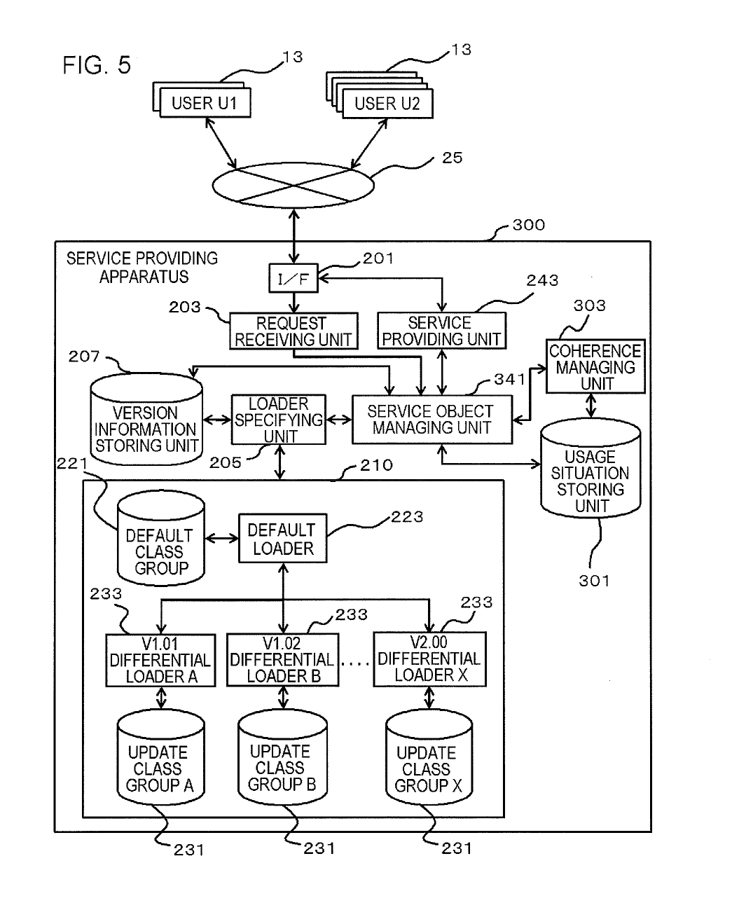

FIG. 5 is a block diagram illustrating a configuration of a service providing system according to an exemplary embodiment of the present invention.

The service providing system according to the exemplary embodiment differs from the above exemplary embodiment in maintaining coherence of a service to be provided while checking a usage situation of the service used by a user.

The service providing apparatus 200 according to the exemplary embodiment can solve a problem that a service becomes inconsistent on the user side upon a service update in the case where a plurality of versions of services matching different requests from a plurality of users are provided to a plurality of the users.

This problem will be described in detail below. There are cases where the user implements the user's application by combining some functions of provided services. In this case, functions of services are sequentially invoked and used in a series of user side application processing. This is because, in this case, if the service side updates a version to a new one suddenly without taking into account the user side application processing at all, an older version of a function and the new version of the function are invoked in a mixed manner in the middle of a series of processing.

The service providing system according to the exemplary embodiment can solve the problem that inconsistency occurs on the user side, by maintaining consistency of a service to provide while checking the user's usage situation of the service.

The service providing apparatus 300 according to the exemplary embodiment further includes: a usage situation storing unit 301 which manages a usage situation of each version of the service used by the users 13; and a coherence managing unit 303 which determines for each user 13 a version of a service in use based on the usage situation managed by the usage situation storing unit 301, and uses the same version until the users 13 finishes a series of use of this version of the service, thereby maintaining coherence of the service provided per users 13.

More specifically, the service providing apparatus 300 according to the exemplary embodiment includes the same configuration as that of the service providing apparatus 200 according to the above exemplary embodiment in FIG. 1. The service providing apparatus 300 according to the exemplary embodiment includes a service object managing unit 341 in place of the service object managing unit 241, and further includes a usage situation storing unit 301 and a coherence managing unit 303.

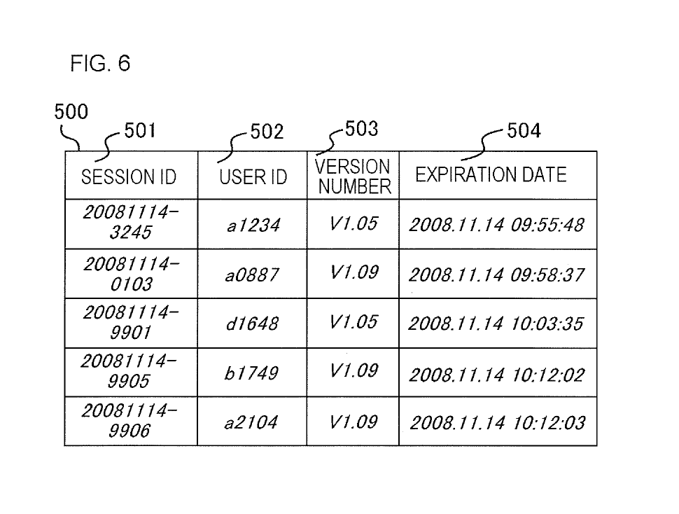

The usage situation storing unit 301 manages a usage situation of each version of the services used by the user 13. FIG. 6 is a view illustrating an example of a structure of a session information table 500 stored in the usage situation storing unit 301. As illustrated in FIG. 6, the session information table 500 includes a session ID column 501 for identifying a session, a user ID column 502, a version number column 503 and an expiration date column 504.

Back to FIG. 5, the coherence managing unit 303 manages a group of a series of requests from the users 13, determines a version of the service in use for each of the users 13 based on the usage situation managed by the usage situation storing unit 301, and uses the same version until the user 13 finishes a series of use of this version of the service, thereby maintaining coherence of the service provided for each user 13.

The service object managing unit 341 obtains version information which needs to be provided to the users 13, from the loader specifying unit 205, and inquires of the coherence managing unit 303 whether or not there is a record of the corresponding session ID in the session information table 500 based on the user ID and the version information. When there is a record of a corresponding session ID in the session information table 500, the service object managing unit 341 requests to the loader specifying unit 205 any one of the versions of the differential loaders 233 recorded in this record and the default loader 223. When there is no record of a corresponding session ID in the session information table 500, the service object managing unit 341 requests any one of the versions of the differential loaders 233 returned previously from the loader specifying unit 205 and the default loader 223.

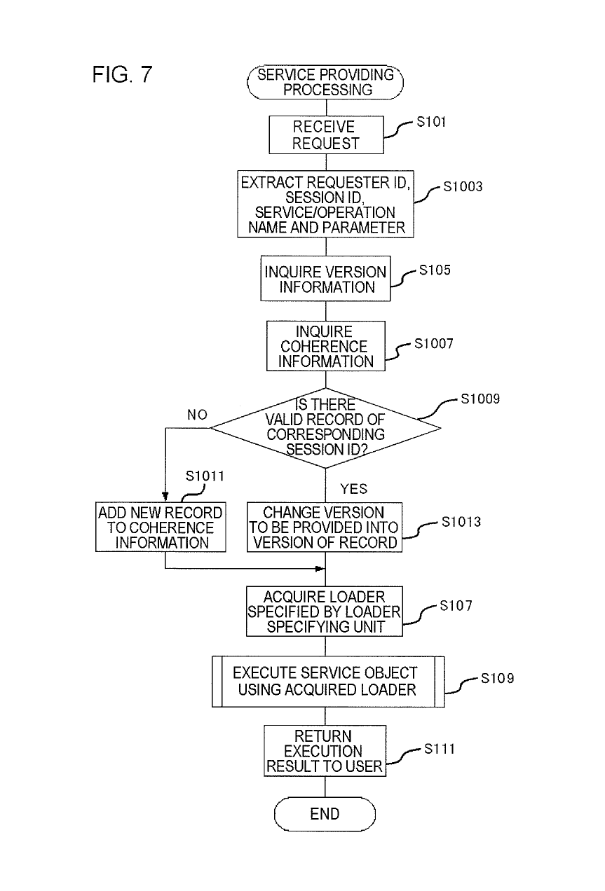

The operation of the service providing apparatus 300 according to the exemplary embodiment thus configured will be described below. FIG. 7 is a flowchart illustrating an example of an operation of the service providing system according to the exemplary embodiment of the present invention. The operation will be described below using FIGS. 5 to 7.

The method of processing data in the service providing apparatus according to the exemplary embodiment includes: managing, by the service providing apparatus 300, the usage situation of each version of the services used by the users 13 in the session information table 500; determining, by the service providing apparatus 300, for each user 13 a version of the service in use based on the usage situation in the session information table 500 (steps S1007 to S1013); and using, by the service providing apparatus 300, the same version until this user 13 finishes a series of use of this version of the service, thereby maintaining coherence of the service provided to each of the users 13.

More specifically, the service providing apparatus 300 according to the exemplary embodiment includes the same step S101, and step S105 to step S111 as in the flowchart in FIG. 3 of the service providing apparatus 200 according to the above exemplary embodiment, and further includes step S1003, step S1007, step S1009, step S1011 and step S1013.

The service object managing unit 341 receives request data from the user 13 which the request receiving unit 203 received in step S101, and extracts a user ID, session ID, service or operation name and parameter from the request data from the user 13 to pass to the loader specifying unit 205 (step S1003). Further, the loader specifying unit 205 executes the same processing as in FIG. 3 (step S105), and returns version information which needs to be provided to the user 13, to the service object managing unit 341.

Then, the service object managing unit 341 inquires of the coherence managing unit 303 whether or not there is a record of the corresponding session ID in the session information table 500 (step S1007). When there is a valid record of a corresponding session ID in session information managed by the coherence managing unit 303 (YES in step S1009), and the service object managing unit 341 changes a version of a service which is obtained previously from the loader specifying unit 205 and needs to be provided to the user 13 to the version obtained from the coherence managing unit 303 (step S1013). This results in that the service object managing unit 341 requests to the loader specifying unit 205 any one of versions of the differential loaders 233 recorded in this record and the default loader 223.

On the other hand, when there is no valid record of the corresponding session ID (NO in step S1009), the service object managing unit 241 adds a new record to the session information table 500 of the usage situation storing unit 301, and adds a record configured with this session ID and version information obtained in step S1003 as coherence information (step S1011). That is, the service object managing unit 341 requests to the loader specifying unit 205 any one of versions of the differential loaders 233 returned previously from the loader specifying unit 205 and default loader 223. In addition, when the oldest version is requested, the differential loader 233 is not returned and only the default loader 223 is returned.

Further, the loader specifying unit 205 executes the same processing as in FIG. 3 (step S107), and returns the loader specified in the loader specifying unit 205 to the service object managing unit 241. Further, the service object managing unit 241 performs the same processing as in FIG. 3 (step S109), and the service providing unit 243 provides a service to the user 13 through the network 25 (step S111) and finishes processing.

As described above, the service providing system according to the exemplary embodiment provides the same effect as the above exemplary embodiment. Further, an exemplary advantage according to the invention is that the service providing system according to the exemplary embodiment makes the coherence managing unit 303 manage a series of requests of the user 13 and provides an older version service in parallel with a new version service even after the new version service starts to be provided, thereby making it possible for the user 13 to continue to use the older version service which has been used already by the user 13 until a series of requests are finished. Therefore, inconsistency of the service is not likely to occur on the user 13 side. The service providing system according to the exemplary embodiment thus has a function of maintaining consistency of a service. Therefore, it is able to prevent a trouble that consistency cannot be maintained when, for example, a version is updated in the middle of use of the service provided to the user 13 or when the user 13 changes a designation of the version.

### Third Exemplary Embodiment

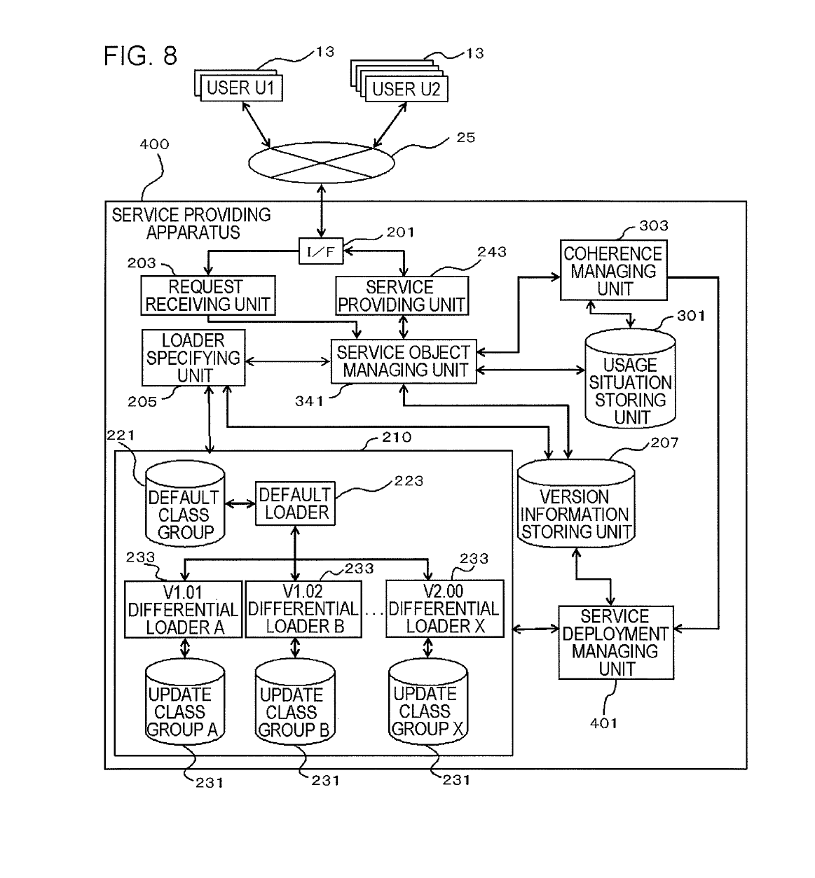

FIG. 8 is a block diagram illustrating a configuration of a service providing system according to the exemplary embodiment of the present invention.

The service providing system according to the exemplary embodiment differs from the above exemplary embodiments in being possible to remove an unnecessary older version service which is not in use, without stopping the system.

The service providing apparatus 400 according to the exemplary embodiment can solve a problem that a service stops upon a service is updated. That is, the service providing apparatus 400 can solve a problem that a plurality of different versions of services requested by a plurality of users cannot be provided unless the services are stopped.

This problem will be described in detail below. This problem has a relationship of trade-off with the problems of the above exemplary embodiments. To prevent inconsistency of a service, it is necessary to, for example, wait for the end of a series of user side application processing which have been operating before the service is updated to a new version. On the other hand, another processing starts when a request of another user side application is additionally received during a series of the user side application processing. Therefore, it is necessary to block a new request until all processing in operation are finished.

The service providing apparatus 400 according to the exemplary embodiment further includes: a determining unit (service deployment managing unit 401) which refers to the usage situation storing unit 301 and the version information storing unit 207 to determine whether or not there is an older version of the service which is not used by any of the users 13; and a deleting unit (service deployment managing unit 401) which, when it is determined that there is an older version of the service which is not in use, deletes the older version of the update class group 231 of this service from the loader managing unit 210, and deletes the corresponding differential loader 233.

More specifically, the service providing apparatus 400 includes the same configuration as the service providing apparatus 300 according to the above exemplary embodiment in FIG. 5, and further includes a service deployment managing unit 401.

The service deployment managing unit 401 manages deployment of classes which configure a service. More specifically, the service deployment managing unit 401 refers to the usage situation storing unit 301 and the version information storing unit 207 to determine whether or not there is an older version service which is not used by any of the users 13. In addition, when it is determined that there is an older version service which is not in use, the service deployment managing unit 401 deletes the update class group 231 of an older version of this service from the loader managing unit 210, and also deletes the corresponding differential loader 233 from the loader managing unit 210.

The service deployment managing unit 401 may control a timing of making the above determination whether or not it is possible to delete the older version service, for example, on a regular basis, and automatically delete the older version service which is not used for a predetermined period of time and over. Alternatively, the service deployment managing unit 401 may delete a specific version service in case there is no user of the specific version service when a request to delete the specific version is received from the administrator of the service providing apparatus 400 through an operation receiving unit (not shown).

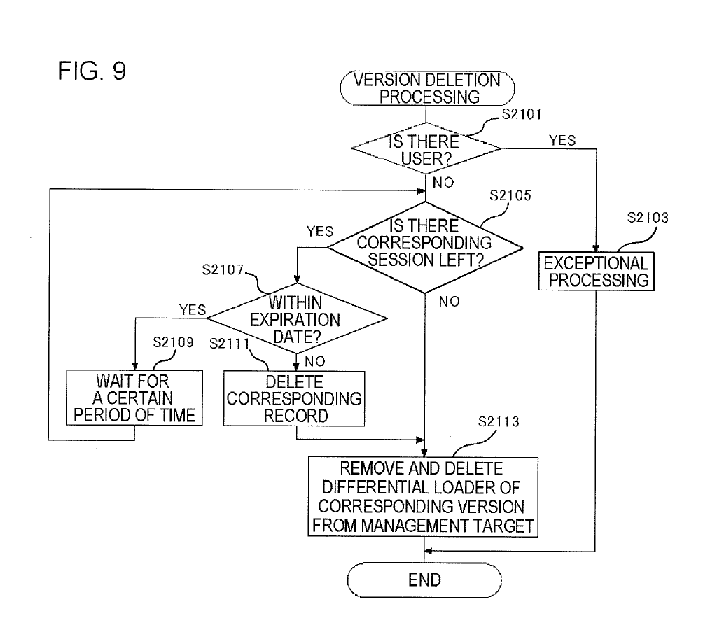

The operation of the service providing apparatus 400 according to the exemplary embodiment thus configured will be described below. FIG. 9 is a flowchart illustrating an example of an operation of a service providing system according to an exemplary embodiment of the present invention. Particularly, FIG. 9 illustrates an example an operation upon deletion of a version of a service object. Hereinafter, the operation will be described using FIGS. 8 and 9.

According to the method of processing data in the service providing apparatus 400 according to the exemplary embodiment, the method of processing data comprises: referring, by the service providing apparatus 400, to the session information table 500 and the version information storing unit 207 to determine whether or not there is an older version of the service which is not used by any of the users (step S2101 and step S2105); and deleting, by the service providing apparatus 400, the older version of the update class group 231 of this service from the loader managing unit 210, and also deleting the corresponding differential loader 233 (step S2113) when it is determined that there is an older version of the service which is not in use.

More specifically, when there is a request to delete a version on a regular basis or there is a request to delete a specific version, the service deployment managing unit 401 inquires of the version information storing unit 207 whether or not there is a user 13 of this version (step S2101). When there is the user 13 (YES in step S2101), since it is not possible to delete this version, an error that it is not possible to delete this version is returned to a requestor, and exceptional processing is performed (step S2103) to finish this processing. When there is no users 13 of this version (NO in step S2101), the service deployment managing unit 401 inquires of the coherence managing unit 303 whether or not there is a session left which uses this version (step S2105). The coherence managing unit 303 refers to the usage situation storing unit 301, and returns whether or not there is the user 13 left, to the service deployment managing unit 401.

When there is no user 13 left (NO in step S2105), the service deployment managing unit 401 removes the differential loader of this version from the management target in the loader specifying unit 205, and deletes the differential loader, that is the differential loader 233 and update class group 231, from the loader managing unit 210 (step S2113) and finishes processing. When there is a session left which uses the corresponding version (YES in step S2105), the service deployment managing unit 401 further inquires of the coherence managing unit 303 whether or not this session is within an expiration date (step S2107). The coherence managing unit 303 refers to the usage situation storing unit 301, and returns whether or not the session is within an expiration date to the service object managing unit 241. If the session is within the expiration date (YES in step S2107), the service object managing unit 241 waits for a certain period of time (step S2109) and then returns to S2105 to repeat processing. If the session is after the expiration date (NO in step S2107), the service deployment managing unit 401 makes the coherence managing unit 303 delete the record of the corresponding session from session information in the session information table 500 of the usage situation storing unit 301 (step S2111). Further, the service object managing unit 241 deletes the differential loader 233 and update class group 231 from the loader managing unit 210 (step S2113), and finishes processing.

As described above, with the service providing apparatus 400 according to the exemplary embodiment, in parallel with the operation of providing a service, the service deployment managing unit 401 can deploy a new version service in cooperation with the loader specifying unit 205 and coherence managing unit 303 under the management of the service by the administrator of the service providing apparatus 400.

As described above, the service providing system according to the exemplary embodiment can provide the same effect as the above exemplary embodiments. Further, an exemplary advantage according to the invention is that the service providing system according to the exemplary embodiment can remove an unnecessary older version service which is not in use without stopping the system and can thereby prevent a memory use capacity of the loader managing unit 210 of the service providing apparatus 400 from being wasted for an unnecessary older version service and, consequently, reduce the load.

Another exemplary embodiment according to the present invention may be provide a method of performing exceptional processing includes, in the version deletion processing in FIG. 9, returning an error without waiting for a certain period of time in S2109 when the corresponding session within an expiration date is left. The method in FIG. 9 goes into an infinite loop until there is no corresponding session or the session passes the expiration date. The steps according to this exemplary embodiment are effective when a user interface which performs a procedure to delete a version needs to be implemented to end after showing to the service administrator that the corresponding session within an expiration date is left.

### Fourth Exemplary Embodiment

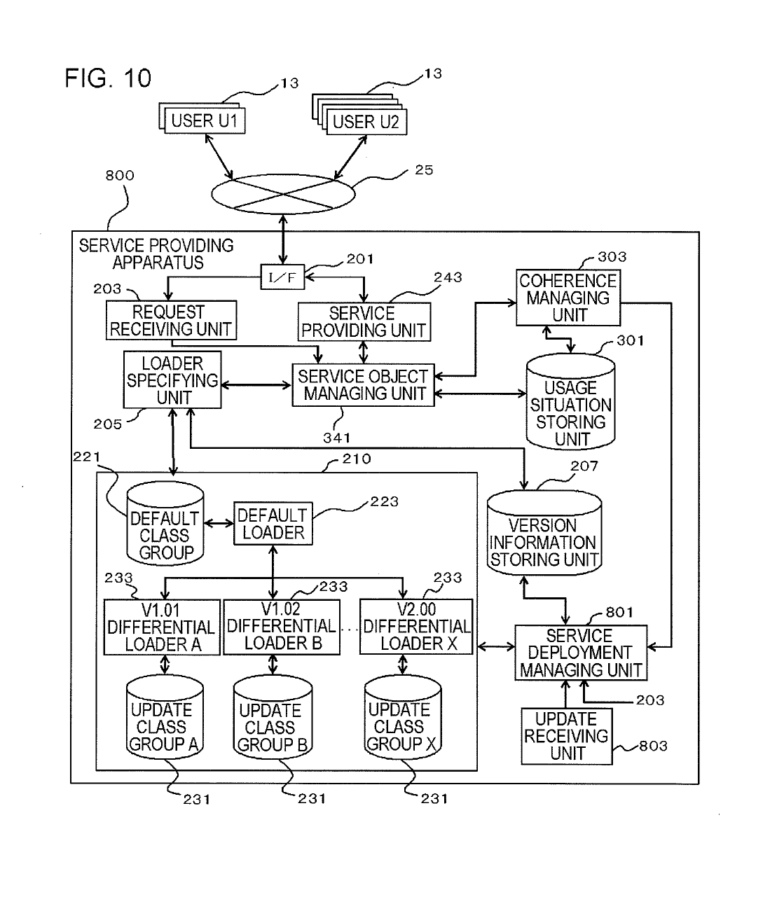

FIG. 10 is a block diagram illustrating a configuration of a service providing system according to an exemplary embodiment of the present invention.

The service providing system according to the exemplary embodiment differs from the above exemplary embodiments in being possible to add and update a new version service without stopping the system.

A service providing apparatus 800 according to the exemplary embodiment further includes: an update receiving unit 803 which receives a newly updated new version of the differential class group; and an adding unit (service deployment managing unit 801) which adds the received new version of the differential class group to the last version of the update class group 231 to form and store the new version of the update class group 231 in the loader managing unit 210, and adds a new version of the differential loader 233 associated with the new version of the update class group 231.

Further, the service providing apparatus 800 further includes: a designation receiving unit (request receiving unit 203) which receives, from the user 13, a designation of a service and a version of this service which the user 13 intends to use; and a registering unit (service deployment managing unit 801) which registers the service designated by the user 13 and version information of the version of the service in the version information storing unit 207 in association with the user 13.

More specifically, the service providing apparatus 800 includes the same configuration as the service providing apparatus 300 according to the above exemplary embodiment in FIG. 5, and further includes a service deployment managing unit 801 and an update receiving unit 803. Instead, the service providing apparatus 800 may include the same configuration as the service providing apparatus 400 except that the service deployment managing unit 401 of the service providing apparatus 400 according to the above exemplary embodiment in FIG. 8 is replaced with the service deployment managing unit 801. Further, the service deployment managing unit 801 may also have the same function as the service deployment managing unit 401 in addition to the functions as described below.

The update receiving unit 803 receives an addition/registration request of a specific new version of a differential class group which is newly updated by the administrator.

The service deployment managing unit 801 adds, to the last version of the update class group 231, the new version of the differential class group corresponding to the addition/registration request which is received by the update receiving unit 803 to form and store the new version of the update class 231 in the loader managing unit 210, and adds the new version of the differential loader 233 associated with this new version of the update class group 231 to the loader managing unit 210.

Further, the service deployment managing unit 801 registers and stores the service and version information of the version thereof designated by the user 13 in the version information storing unit 207 in association with the user 13.

More specifically, the service deployment managing unit 801 generates a new differential loader according to an addition/registration request, and thereafter registers the new differential loader in the loader managing unit 210 together with a version number. Further, the service deployment managing unit 801 reads and loads the update class group which needs to be deployed in this new differential loader into the loader managing unit 210. Furthermore, when the request receiving unit 203 receives a request for use of a new version service from the user 13, the service deployment managing unit 801 obtains, based on the request for use, the user ID of the user 13, the name and version number of the service which the user 13 intends to use and registers them in the version information storing unit 207 in FIG. 2 in association with each other.

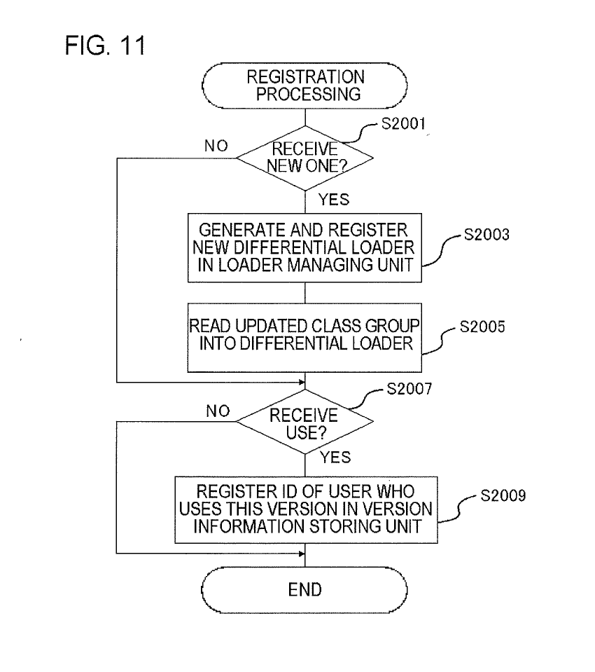

The operation of the service providing apparatus 800 according to the exemplary embodiment thus configured will be described below. FIG. 11 is a flowchart illustrating an example of an operation of the service providing system according to the exemplary embodiment of the present invention. Particularly, FIG. 11 illustrates an example of a registration operation upon addition of a version of a service object. Hereinafter, the operation will be described using FIGS. 10 and 11.

The method of processing data in the service providing apparatus according to the exemplary embodiment includes: receiving, by the service providing apparatus 800, a newly updated new version of the differential class group (step S2001); and adding, by the service providing apparatus 800, the received new version of the differential class group to the last version of the update class group 231 to form and store the new version of the update class group 231 in the loader managing unit 210, and adding the new version of the differential loader 233 associated with the new version of the update class group 231 to the loader managing unit 210.

The method of processing data in the service providing apparatus of the exemplary embodiment includes: receiving, by the service providing apparatus 800, from the user 13, a designation of a service and a version of this service which the user 13 intends to use (step S2007); and registering, by the service providing apparatus 800, the service and version information of the version of this service designated by the user 13 in the version information storing unit 207 in association with the user (step S2009).

More specifically, when the update receiving unit 803 receives an addition request of a specific version (YES in step S2001), the service deployment managing unit 801 generates and registers a new differential loader in the loader managing unit 210 together with its version number (step S2003). Further, the service deployment managing unit 801 reads and loads the update class group which needs to be deployed to this new differential loader into the loader managing unit 210 (step S2005). Further, when the request receiving unit 203 receives a request to use a new version service, from the users 13 (YES in step S2007), the service deployment managing unit 801 obtains, based on the request for use, the user ID of the user 13, the name use and version number the service which the user 13 intends to use and registers them in the version information storing unit 207 in FIG. 2 in association with each other (step S2009).

As described above, with the service providing apparatus 800 according to the exemplary embodiment, in parallel with the operation of providing a service, the service deployment managing unit 801 can cancel deployment of the older version service in cooperation with the loader specifying unit 205 and coherence managing unit 303 and delete the older record managed by the coherence managing unit 303 under the management of the service by the administrator of the service providing apparatus 800.

As described above, the service providing system according to the exemplary embodiment provides the same effect as the above exemplary embodiments. Further, an exemplary advantage according to the invention is that the service providing system according to the exemplary embodiment can start a new version without waiting for the end of the older version service and update the service only by adding a new version of the differential loader without replacing the entire system, thereby making it possible to update the service while continuing the service. By this means, the service providing apparatus 800 can add a new version of the service which is newly updated without stopping the system.

### Fifth Exemplary Embodiment

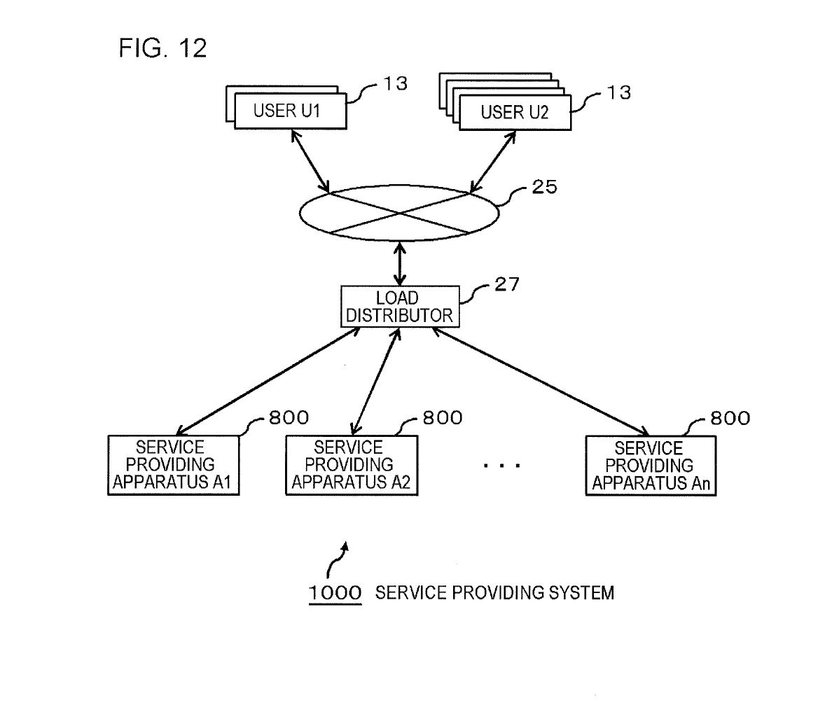

FIG. 12 is a block diagram illustrating a configuration of a service providing system according to an exemplary embodiment of the present invention.

The service providing system according to the exemplary embodiment differs from the above exemplary embodiments in including a plurality of service providing apparatus. In the exemplary embodiment, a plurality of service providing apparatuses includes the same configuration, and includes loaders and class groups which provide services of the same version configuration.

The service providing system 1000 according to the exemplary embodiment can solve a problem that the continuation of providing the service is liable to be cost when the user requests to continue getting an older version of the service.

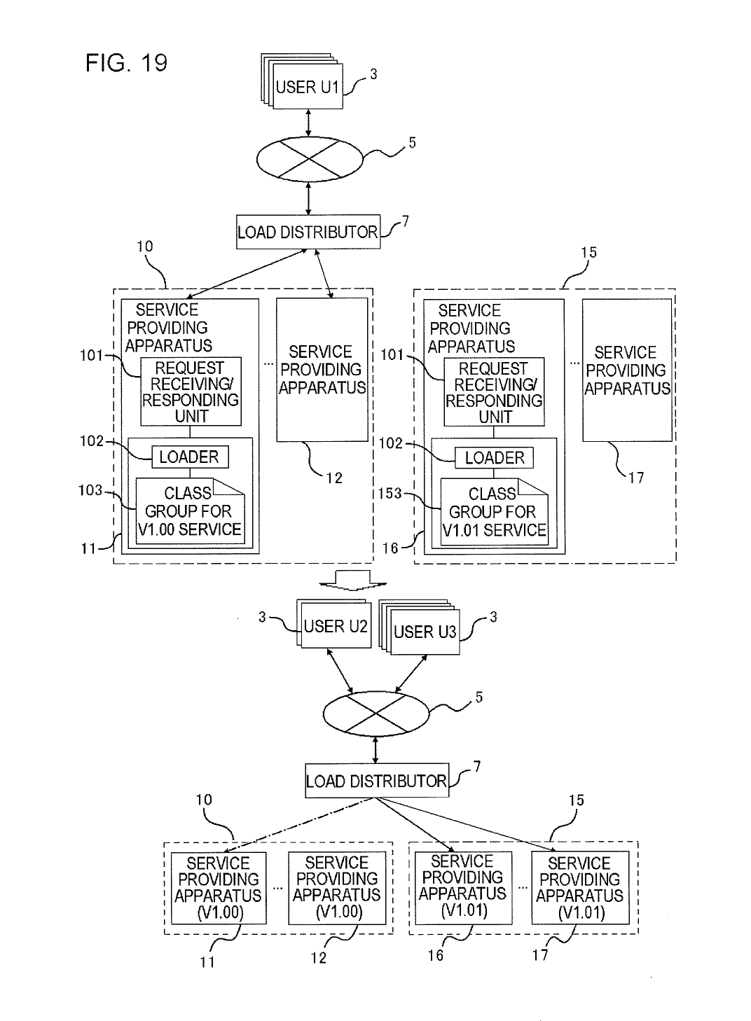

This problem will be described in detail below. A conventional method which is operated by allocating dedicated hardware and virtual OS to an older version requires certain hardware resources to provide the older version. One of the reasons why the certain hardware resources are needed is that the method of the related art shown in FIG. 19 needs to secure at least one service providing apparatus for an older version service. Therefore, it is difficult to adjust calculator resources following the number of uses in a detailed manner while the number of the users which use the older version of the service decreases in general. Further, there is another reason in a case where there are multiple versions which need be continuously provided. Another reason is that the managements of the service class groups respective version of which slightly differs from each other in each service providing apparatus becomes cumbersome, thereby increasing the management cost.

The service providing system 1000 according to the exemplary embodiment includes a load distributing apparatus (load distributor 27) which determines the service providing apparatus 800 for providing a service in response to the request of the user 13 according to load states of a plurality of the service providing apparatuses 800 (A1, A2, . . . and An) according to the above exemplary embodiments and allocates the service providing apparatus 800. A plurality of the service providing apparatuses 800 stores the same version of the default class group 221 (FIG. 10) in the default class group storing unit (loader managing unit 210: FIG. 10), thereby equally providing to the users all versions of all services which are being applied to use, and stores each of all the same versions of the update version-specific class groups (update class group 231: FIG. 10) which are being applied to use in the update version-specific lass storing unit (loader managing unit 210: FIG. 10).

According to this configuration, since a plurality of service providing apparatuses include the same configurations, it is not necessary to take the load into account in advance even when the number of users or load varies depending on services. Therefore, it is easier to construct the system than another case where a server is separately assigned to respective services or versions. This results in that it is possible to add or replace a server without stopping the system, thereby making it easy to achieve the distribution of the load.

The users 13 (users U1 and U2 in FIG. 12) transmit service requests to at least one of the service providing apparatuses 800 (a plurality of service providing apparatuses A1, A2, . . . and An) through the load distributor 27.

After adequate processing is performed by the service object, the service providing apparatus 800 then returns a processing result to the user 13. In order to process a great amount of service requests from the users 13, the load distributor 27 is connected with and adequately assigns processing to a plurality of service providing apparatuses 800. When the service providing apparatuses 800 have very high performance or when service requests from the users 13 are not so many, there may be also cases where only one service providing apparatus 800 processes service requests of all users without the load distributor 27.

In addition, the load distributor 27 may be configured with a common apparatus, and is irrelevant to the essence of the present invention and therefore will not be repeated.

Moreover, in the exemplary embodiment, a plurality of service providing apparatuses 800 delete older version services or register new version services in the same manner, and maintain the same configuration with each other.

An exemplary advantage according to the invention is that the service providing system 1000 according to the exemplary embodiment can promote efficiency of the calculator resources required to continue providing the older version services. That is, it is possible to reduce cost to provide a plurality of versions of the services. This is because only an update class of each version of the service of which is requested may be held and common classes maybe shared, thereby making it unnecessary to multiply read classes.

Further, since one apparatus can provide a plurality of versions of the services, this apparatus can be operated as a service providing apparatus for providing another version even when the number of users who use a specific version is small. Consequently, the efficiency to use hardware resources becomes high. Namely, the preparation of the apparatuses for each version causes the usage situation of resources of each apparatus to vary depending on the usage situation of the respective versions. As a result, it becomes necessary to adjust the deployment of the apparatuses. However, the service providing system according to the exemplary embodiment needs not make a plan by predicting usage situations of the users. Further, this is also one of the reasons why the problem can be solved that any service providing apparatuses can be operated with the same configuration, thereby making it possible to reduce their operational cost.

### Sixth Exemplary Embodiment

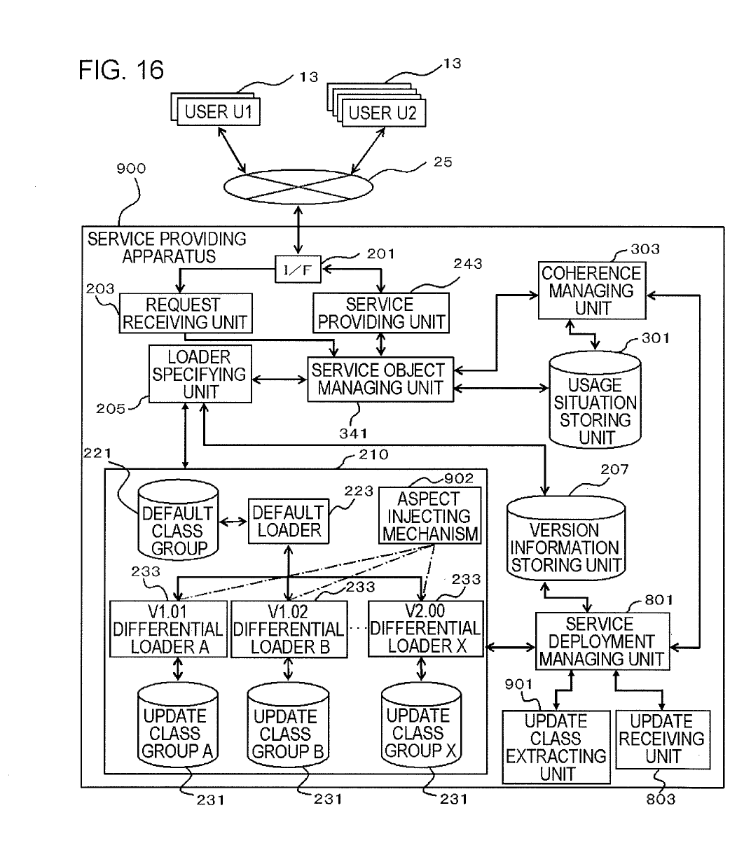

FIG. 16 is a block diagram illustrating a configuration of a service providing system according to an exemplary embodiment of the present invention. The service providing system according to the exemplary embodiment differs from the above fourth exemplary embodiment in FIG. 10 in that it is possible to add and update a new version without stopping the system when the setting for cross-cutting changing the service is designated to the new version service. In addition, the service providing system according to the exemplary embodiment in FIG. 16 is also applicable to the service providing systems according to above exemplary embodiments in FIGS. 8 and 12.

In the fourth exemplary embodiment, it is assumed that the new version of the update class group is received by the update receiving unit 803 when receiving a new version service with the fourth. There is a technique, such as Aspect Oriented Programming (AOP) that automatically updates the corresponding class by designating the setting of cross-cutting changes in the services in instead of explicitly giving a class group which is updated. This technique permits a uniform change of a portion of a program code having constant property and permits a dynamic direct change of an existing execute binary without recompilation. Hereinafter, these cross-cutting changes in the services are referred to as “Aspect” and the setting of these changes is referred to as “Aspect definition”.

When the service is dynamically updated using the technique such as AOP, the Aspect injecting mechanism applies the Aspect to the corresponding class, the class being loaded to the class loader. Essentially, the entire classes configuring the service are reloaded onto the class loader to then apply the Aspect. However, this leads to the fact that all classes are multiply loaded onto the differential loaders, thereby making it inefficiency. Hence, there is provided, in the exemplary embodiment, a system which registers points of the cross-cutting changes in the services as a mechanism upon deployment of the new version of the service such as AOP. Thus, this system can efficiently provide a service without stopping other services even when the new version is registered due to the update of the service for the entire service of the kind which automatically updates a plurality of the classes.

As illustrated in FIG. 16, the service providing system according to the exemplary embodiment includes a service providing apparatus 900 in place of the service providing apparatus 800 in FIG. 10.

The service providing apparatus 900 according to the exemplary embodiment further includes: an update receiving unit 803 which receives a setting (Aspect definition) in which a change rule of a new version ranging over an overall service is described; an update class extracting unit 901 which extracts only a class of a target for change based on the setting; and an adding unit (service deployment managing unit 801) which, while applying a change only to the extracted target class for the change, adds the changed class group (differential class group) to the last version of the update version-specific class group (differential class group 231) to form and store the new version of the update version-specific class group (differential class group 231) in an update version-specific class group storing unit (loader managing unit 210), and adds the new version of the update version-specific differential loading unit (differential loader 233) associated with the new version of the update version-specific class group (differential class group 231).

More specifically, the service providing apparatus 900 according to the exemplary embodiment includes the same configuration as the service providing apparatus 800 in FIG. 10, and further includes an update class extracting unit 901 and an Aspect injecting mechanism 902.

In the service providing apparatus 900 according to the exemplary embodiment, the update receiving unit 803 receives a service update according to the Aspect definition. When the update receiving unit 803 receives the service update according to the Aspect definition, the service deployment managing unit 801 inquires of the update class extracting unit 901 which class of the service in present use needs to be updated. Further, the service deployment managing unit 801 instructs the loader managing unit 210 to load only target class for the update into the newly generated new version of the differential loader.

The update class extracting unit 901 checks the Aspect definition received by the update receiving unit 803 as to which class of the service in present use needs to be updated according to an inquiry from the service deployment managing unit 801, and extracts the target class for the update to return to the service deployment managing unit 801. That is, upon a service update, the update class extracting unit 901 checks in advance which class will be updated at the change point.

The loader managing unit 210 loads the updated target class designated by the service deployment managing unit 801 onto a new differential loader. In this case, the Aspect injecting mechanism 902 simultaneously works to instruct each differential loader 233 to apply the change based on the registered Aspect definition to the update target class. That is, the loader managing unit 210 updates the class according to the change point registered when the update class extracting unit 901 reads the extracted corresponding class onto the update version of the differential loader.

By doing so, even when a new version is registered following a service update of the overall service such as

AOP, it is possible to efficiently provide a service without stopping any other services.

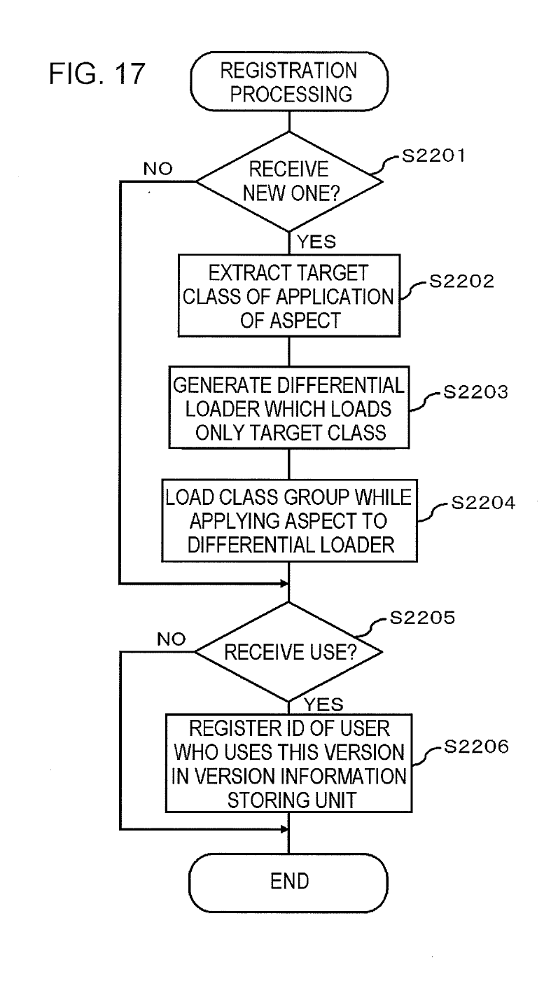

Next, the entire registration operation upon addition of a version of a service object in the service providing system according to the exemplary embodiment will be described in detail. FIG. 17 is a flowchart illustrating an example of a registration operation upon addition of a version of a service object in the service providing system according to an exemplary embodiment of the present invention. Hereinafter, the operation will be described by using FIGS. 16 and 17.

The method of processing data in the service providing apparatus according to the exemplary embodiment includes receiving, by the service providing apparatus 900, a setting (Aspect definition) in which a change rule of a newly updated new version ranging over the entire service is described (YES in step S2201). Further, the service deployment managing unit 801 passes the registered Aspect definition to the update class extracting unit 90. Then, the update class extracting unit 901 extracts only a class which is the target to apply Aspect in which content of change of a version to be added is described to return it to the service deployment managing unit 801 (step S2202). When a new version is not received (NO in step S2201), the step proceeds to step S2205.

The service deployment managing unit 801 generates a differential loader which loads only this Aspect application target class group to the loader managing unit 210 as a class loader for a new version (step S2203). Further, the service deployment managing unit 801 loads the above Aspect application target class group to this new differential loader while applying the Aspect in the Aspect injecting mechanism 902 (step S2204).

The method of processing data in the service providing apparatus according to the exemplary embodiment further includes: receiving, by the service providing apparatus 900, form the users 13, a designation of a service and a version of the service which said user intends to use (YES in step S2205), and registering, by the service providing apparatus 900, the service and version information of the version of this service designated by the users 13, in the version information storing unit 207 in association with the user (step S2206). When the use is not received (NO in step S2205), this flowchart is finished.

### EXAMPLE

The operation of the best mode for implementing the present invention will be described with reference to FIGS. 2, 6, and 12 to 15 by using a specific example. Meanwhile, the following is one example, and the operation and data format are by no means limited to this. The present example will be described by using the service providing system 1000 according to the above exemplary embodiments as an example.

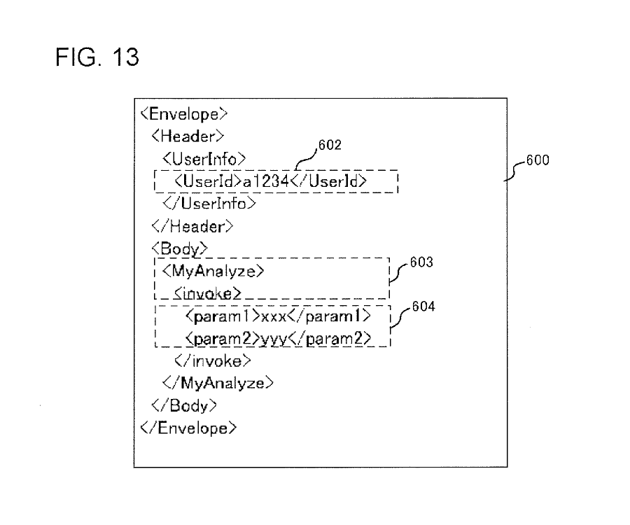

First, FIG. 13 illustrates an example of initial request data from the user. In this example, request data 600 is described in the form of EXtensible Markup Language (XML and http://www.w3.org/TR/xml), and is transmitted from the user using the protocol such as HyperText Transfer Protocol (HTTP and RFC2616). Based on this request data, the service providing apparatus 800 generates an adequate service object for the user.

This request data includes a user ID 602 in which the user ID is designated and also a service identifying part 603 in which a service and an operation are designated as “MyAnalyze” and “invoke”, respectively. This request data further includes a parameter designating part 604 in which a parameter for the service is designated. Assuming that this request data 600 is the first one of a series of service requests, there is no created session or no session information in this data.

The service object managing unit 341 of the service providing apparatus 800 inquires of the version information storing unit 207 based on the request data 600 to determine which version of the service to use. With the example of the version information storing unit 207 in FIG. 2, records of user ID “a1234” and service “MyAnalyze” are searched among the version information management table 700, to then make a version number “V1.05” in the corresponding version number column return. If there is no corresponding record, the latest version number at that point of time is returned.

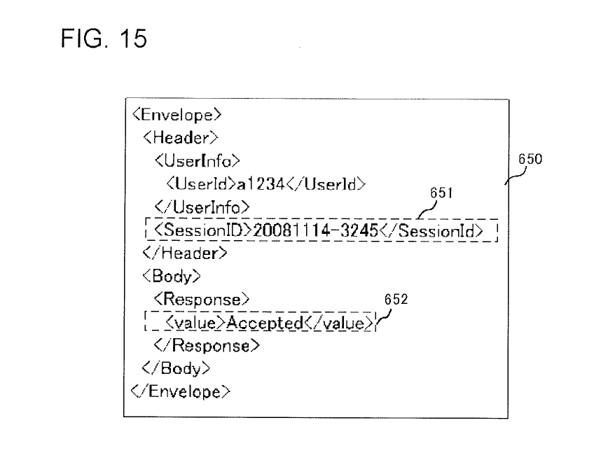

The service object managing unit 341 obtains a differential loader for “V1.05”, from the loader specifying unit 205, and generates a service object of “MyAnalyze”. Further, the operation “invoke” of this service object is given arguments of “xxx” and “yyy” and executed to then return a result of the execution to the user. FIG. 15 illustrates an example of the response. The returned response 650 includes a session ID 651 used to continue a series of subsequent services and a service processing result 652. In this example, a result that processing is received is returned.

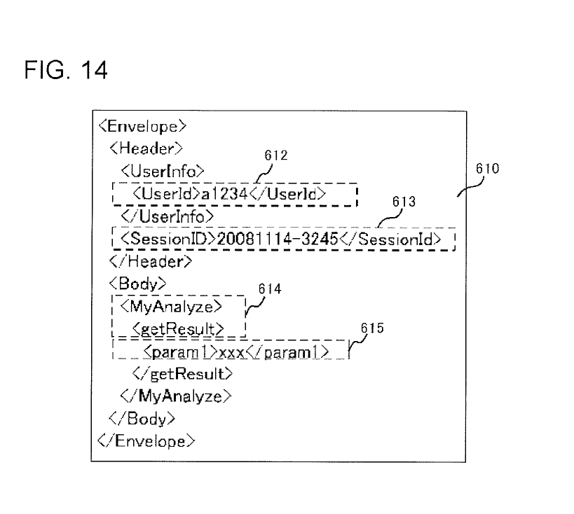

Next, FIG. 14 illustrates an example of request data when a series of services are continued. This request data 610 makes an operation “getResult” execute to obtain results of processing the service “MyAnalyze” and the operation “invoke”. The request data 610 includes session information 613, so that the service object managing unit 341 makes the coherence managing unit 303 search the session information table 500 for version information corresponding to the session “20081114-3245”. FIG. 6 illustrates session information stored in the session information table 500 managed by the coherence managing unit 303.

The coherence managing unit 303 searches this session information table 500 for a record corresponding to the session ID included in the request data, and determines whether or not information of the record is valid based on a value of the expiration date column 504 of the corresponding record. In this case, the record is valid, and therefore the value of “V1.05” in the version number column 503 is returned. The service object managing unit 341 obtains the differential loader for the returned version number “V1.05” from the loader specifying unit 205, and executes the processing of the service “MyAnalyze” and the operation “invoke” and then returns results of the processing to the user.

When a service is additionally requested, session information is not attached to such as the request data 600. This makes it possible to execute the service according to the service object in the version stored in advance in the version information storing unit 207 or the latest version. When this service request is a part of a series of the service requests, session information includes therein a session ID indicative of the same as a series of the service. By this means, the service in the version provided when the session information is obtained is continued, and the loader in this version is not discarded while this session is valid.

The service deployment managing unit 801 accesses the coherence managing unit 303 on a regular basis, searches the session information of the session information table 500 for records in which values in the expiration column 504 indicate times before the current time, and then deletes these records from the session information table 500.

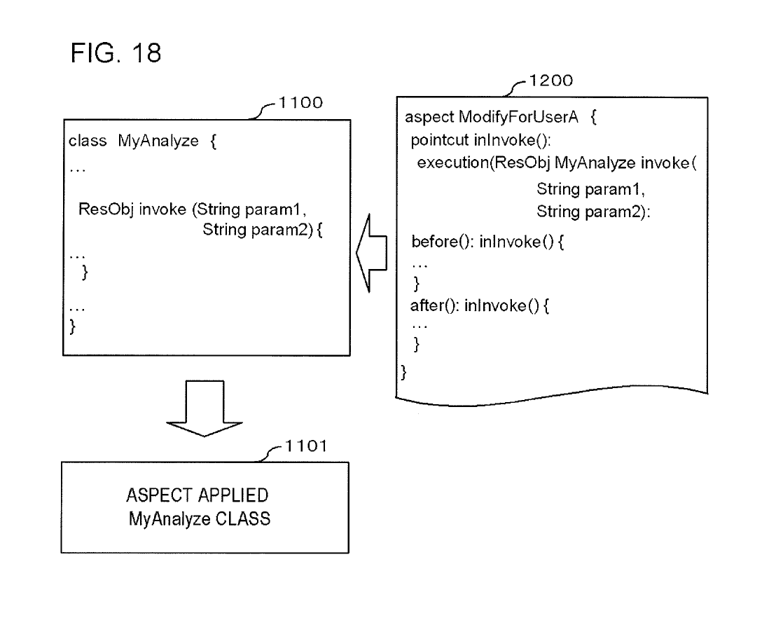

Next, an example of deployment of a new version service according to the present example will be described using FIGS. 16 and 18.

The new version service according to the present invention is deployed as Aspect for the class of the default class group 221 loaded on the default loader 223 by the administrator through the update receiving unit 803.

The example of an Aspect definition 1200 in FIG. 18 is an example of description in AspectJ (http://www.eclipse.org/aspectj/). When this Aspect definition 1200 is deployed as renewed content for a new version service, the update class extracting unit 901 analyzes the Aspect definition 1200 and extracts a MyAnalyze class (default class) 1100 for which its content will be updated. Next, the loader managing unit 210 generates a new version of the differential loader which loads only this MyAnalayze class 1100. The Aspect injection mechanism 902 applies the Aspect definition 1200 to the MyAnalyze class 1100, so as to renew the MyAnalyze class 1101 to which the Aspect has been applied already. Then the Aspect applied MyAnalyze class 1101 is loaded into the above differential loader.

The only class to which the Aspect needs to be applied is extracted in advance and the Aspect is applied to this class on a dedicated class loader, so that it is possible to make a single service providing apparatus provide services to which various versions of the Aspects are applied respectively, without stopping the entire services.

Although exemplary embodiments of the present invention have been described with reference to the drawings above, these exemplary embodiments are examples of the prevent invention and various configurations other than the above can be employed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

In addition, with the present invention, information regarding the user are obtained and used legally.

This application is based upon and claims the benefit of priority from Japanese Patent Application No. 2009-083117, filed on Mar. 30, 2009, and Japanese Patent Application No. 2010-41474, filed on Feb. 26, 2010, the disclosure of which are incorporated herein in their entirety by reference.

1. A service providing apparatus comprising:
a version information storing unit which stores therein services to be provided to each of users, and version information of said service, said service and said version information being associated with each other;
a default class group storing unit which stores therein a default class group having the oldest version among said services to be provided to said users;
an update version-specific class group storing unit which stores therein update version-specific class groups for respective versions updated subsequent to said oldest version, said update version-specific class group including a differential class group having a difference with said default class group;
a default loading unit which reads out and executes said default class group stored in said default class group storing unit;
an update version-specific differential loading unit which is provided to each of said update version-specific class groups, and which reads out and executes each of said update version-specific class groups stored in said update version-specific class group storing unit;
a receiving unit which receives a request for use of said service from said user;
a specifying unit which refers to said version information storing unit to specify a version suitable for said user from whom said request is received;
a service object managing unit which generates a service object of the specified version suitable for said user and executes processing, by using said default loading unit and said update version-specific differential loading unit associated with the specified version of said update version-specific class group; and
a providing unit which provides said service matching said request to said user according to a result of executing said processing.

2. The service providing apparatus according to claim 1, further comprising:
a usage situation managing unit which manages a usage situation of each version of said services used by said users; and
a coherence managing unit which determines for each user a version of said service in use, based on said usage situation managed by said usage situation managing unit, and uses the same version until said user finishes a series of use of said version of said service, thereby maintaining coherence of said service provided to each of said users.

3. The service providing apparatus according to claim 2, further comprising:
a determining unit which refers to said usage situation managing unit and said version information storing unit to determine whether or not there is an older version of said service which is not used by any of said users; and
a deleting unit which, when it is determined that there is an older version of said service which is not in use, deletes said older version of said update version-specific class group of said service from said update version-specific class group storing unit, and deletes the corresponding update version-specific differential loading unit.

4. The service providing apparatus according to claim 2, further comprising:
an update receiving unit which receives a newly updated new version of said differential class group; and
an adding unit which adds the received new version of the differential class group to the last version of said update version-specific class group to form and store the new version of said update version-specific class group in said update version-specific class group storing unit, and adds the new version of said update version-specific differential loading unit associated with said new version of said update version-specific class group.

5. The service providing apparatus according to claim 2, further comprising:
an update receiving unit which receives a setting in which a change rule of a new version ranging over an overall service is described;
an update class extracting unit which extracts only a class of a target to change based on said setting; and
an adding unit which, while applying a change only to the extracted class of said target to change, adds said changed class group to the last version of said update version-specific class group to form and store the new version of said update version-specific class group in said update version-specific class group storing unit, and adds the new version of said update version-specific differential loading unit associated with the new version of said update version-specific class group.

6. The service providing apparatus according to claim 1, further comprising:
a designation receiving unit which receives, from said user, a designation of a service and a version of said service which said user intends to use; and
a registering unit which registers said service designated by said user and version information of said version of said service in said version information storing unit in association with said user.

7. A service providing system comprising:
a plurality of service providing apparatuses according to claim 1; and
a load distributing apparatus which determines a service providing apparatus which provides a service in response to a request of a user according to load states of said plurality of service providing apparatuses, and assigns said service providing apparatus,
wherein said plurality of service providing apparatuses stores the same version of said default class group in said default class group storing unit, thereby equally providing to said user all versions of all services which are being applied to use, and stores each of all the same versions of said update version-specific class groups which are being applied to use in said update version-specific class group storing unit.

8. A method of processing data in a service providing apparatus, wherein said service providing apparatus comprises:
a version information storing apparatus which stores therein services to be provided to each of users, and version information of said service, said service and said version information being associated with each other;
a default class group storing apparatus which stores therein a default class group having the oldest version among said services to be provided to said users;
an update version-specific class group storing apparatus which stores therein update version-specific class groups for respective versions updated subsequent to said oldest version, said update version-specific class group including a differential class group having a difference with said default class group;
a default loader which reads out and executes said default class group stored in said default class group storing apparatus; and
an update version-specific differential loader which is provided to each of said update version-specific class groups, and which reads out and executes each of said update version-specific class groups stored in said update version-specific class group storing apparatus; wherein
said method of processing data comprises:
storing, by said service providing apparatus, services to be provided to each of users, and version information of said service in said version information storing apparatus, said service and said version information being associated with each other;
storing, by said service providing apparatus, said default class group in said default class group storing apparatus;
storing, by said service providing apparatus, said update version-specific class group in said update version-specific class group storing apparatus for each version updated subsequent to said oldest version;
receiving, by said service providing apparatus, a request for use of said service from said user;
referring, by said service providing apparatus, to said version information storing unit to specify a version suitable for said user whom said request is received;
generating, by said service providing apparatus, a service object of the specified version suitable for said user and executing processing, by using said default loader and said update version-specific differential loader associated with the specified version of said update version-specific class group; and
providing, by said service providing apparatus, said service matching said request to said user according to a result of executing said processing.

9. The method of processing data in the service providing apparatus according to claim 8, wherein
said service providing apparatus further comprises a storing apparatus which stores therein a usage situation management table which manages a usage situation of each version of said services used by said users, wherein
said method of processing data comprises:
managing, by said service providing apparatus, the usage situation of each version of said services used by said users in said usage situation management table;
determining, by said service providing apparatus, for each user a version of said service in use based on said usage situation in said usage situation management table; and
using the same version until said user finishes a series of use of said version of said service, thereby maintaining coherence of said service provided to each of said users.

10. The method of processing data in the service providing apparatus according to claim 9, wherein
said method of processing data comprises:
referring, by said service providing apparatus, to said usage situation management table and said version information storing apparatus to determine whether or not there is an older version of said service which is not used by any of said users; and
deleting, by said service providing apparatus, said older version of said update version-specific class group of said service from said update version-specific class group storing apparatus, and deleting the corresponding update version-specific differential loader when it is determined that there is an older version of said service which is not in use.

11. The method of processing data in the service providing apparatus according to claim 9, wherein
said method of processing data comprises:
receiving, by said service providing apparatus, a newly updated new version of said differential class group; and
adding, by said service providing apparatus, the received new version of said differential class group to the last version of said update version-specific class group to form and store the new version of said update version-specific class group in said update version-specific class group storing apparatus, and adding the new version of said update version-specific differential loader associated with said new version of said update version-specific class group.

12. The method of processing data in the service providing apparatus according to claim 9, wherein
said method of processing data comprises:
receiving, by said service providing apparatus, a setting in which a change rule of a newly updated new version ranging over an overall service is described;
extracting, by said service providing apparatus, only a class of a target to change based on the received setting; and
adding, by said service providing apparatus, said changed class group to the last version of said update version-specific class group, while applying a change only to the extracted class of said target to change to form and store the new version of said update version-specific class group in said update version-specific class group storing apparatus, and adding the new version of said update version-specific differential loader associated with the new version of said update version-specific class group.

13. The method of processing data in the service providing apparatus according to claim 8, wherein
said method of processing data comprises:
receiving, by said service providing apparatus, from said user, a designation of a service and a version of said service which said user intends to use; and
registering, by said service providing apparatus, said service and version information of said version of said service designated by said user in said version information storing apparatus in association with said user.

14. A computer program embodied or recorded on a non-transitory computer readable medium that controls a service providing apparatus, wherein:
a computer comprises:
a version information storing apparatus which stores therein services to be provided to each of users, and version information of said service, said service and said version information being associated with each other;
a default class group storing apparatus which stores therein a default class group having the oldest version among said services to be provided to said users;
an update version-specific class group storing apparatus which stores therein update version-specific class groups for respective versions updated subsequent to said oldest version, said update version-specific class group including a differential class group having a difference with said default class group;
a default loader which reads out and executes said default class group stored in said default class group storing apparatus; and
an update version-specific differential loader which is provided to each of said update version-specific class groups, and which reads out and executes each of said update version-specific class groups stored in said update version-specific class group storing apparatus; wherein
the computer program causes the computer to execute:
a procedure for storing services to be provided to each of said users, and version information of said service in said version information storing apparatus, said service and said version information being associated with each other;
a procedure for storing said default class group in said default class group storing apparatus;
a procedure for storing said update version-specific class group in said update version-specific class group storing apparatus for each version updated subsequent to said oldest version;
a procedure for receiving a request for use of said service from said user;
a procedure for referring to said version information storing apparatus to specify a version suitable for said user from whom said request is received;
a procedure for generating a service object of the specified version suitable for said user and executing processing, by using said default loader and said update version-specific differential loader associated with the specified version of said update version-specific class group; and
a procedure for providing said service matching said request to said user according to a result of executing said processing.

15. The computer program according to claim 14, wherein the computer further comprises a storing apparatus which stores therein a usage situation management table which manages a usage situation of each version of said services used by said users, and
the computer program causes the computer to further execute:
a procedure for managing the usage situation of each version of said services used by said users in said usage situation management table;
a procedure for determining for each user a version of said service in use, based on said usage situation in said usage situation management table; and
a procedure for using the same version until said user finishes a series of use of said version of said service, thereby maintaining coherence of said service provided to each of said users.

16. The computer program according to claim 15, causing the computer to further execute:
a procedure for referring to said usage situation management table and said version information storing apparatus to determine whether or not there is an older version of said service which is not used by any of said users; and
a procedure for deleting said older version of said update version-specific class group of said service from said update version-specific class group storing apparatus, and deleting the corresponding update version-specific differential loader, when it is determined that there is an older version of said service which is not in use.

17. The computer program according to claim 15, causing the computer to further execute:
a procedure for receiving a newly updated new version of said differential class group; and
a procedure for adding the received new version of said differential class group to the last version of said update version-specific class group to form and store the new version of said update version-specific class group in said update version-specific class group storing apparatus; and
a procedure for adding the new version of said update version-specific differential loader associated with said new version of said update version-specific class group.

18. The computer program according to claim 15, causing the computer to further execute:
a procedure for receiving a setting in which a change rule of a newly updated new version ranging over an overall service is described;
a procedure for extracting only a class of a target to change based on the received setting; and
a procedure for adding said changed class group to the last version of said update version-specific class group, while applying a change only to the extracted class of said target to change to form and store the new version of said update version-specific class group in said update version-specific class group storing apparatus; and
a procedure for adding the new version of said update version-specific differential loader associated with the new version of said update version-specific class group.

19. The computer program according to claim 14, causing the compute r to further execute:
a procedure for receiving, from said user, a designation of a service and a version of said service which said user intends to use; and
a procedure for registering said service designated by said user and version information of said version of said service in said version information storing apparatus in association with said user.

20. A service providing apparatus comprising:
version information storing means for storing therein services to be provided to each of users, and version information of said service, said service and said version information being associated with each other;
default class group storing means for storing therein a default class group having the oldest version among said services to be provided to said users;
an update version-specific class group storing means for storing therein update version-specific class groups for respective versions updated subsequent to said oldest version, said update version-specific class group including a differential class group having a difference with said default class group;
a default loading means for reading out and executing said default class group stored in said default class group storing means;
an update version-specific differential loading means being provided to each of said update version-specific class groups, and which reads out and executes each of said update version-specific class groups stored in said update version-specific class group storing means;
a receiving means for receiving a request for use of said service from said user;
a specifying means referring to said version information storing unit to specify a version suitable for said user from whom said request is received;
a service object managing means for generating a service object of the specified version suitable for said user and executes processing, by using said default loading means and said update version-specific differential loading means associated with the specified version of said update version-specific class group; and
a providing means for providing said service matching said request to said user according to a result of executing said processing.
